(19) United States
(12) Patent Application Publication
(10) Pub. No.: US 2025/0059961 A1
(43) Pub. Date: Feb. 20, 2025

(54) NANO RELATIVISTIC MOTOR

(71) Applicant: ARIEL SCIENTIFIC INNOVATIONS LTD, Ariel (IL)

(72) Inventor: Asher YAHALOM, Givaat Shmuel (IL)

(21) Appl. No.: 18/720,184

(22) PCT Filed: Dec. 15, 2022
(86) PCT No.: PCT/IL2022/051342

§ 371 Date: Jun. 14, 2024

Related U.S. Application Data
(60) Provisional application No. 63/290,064, filed on Dec. 16, 2021.

(51) Int. Cl. F03H 3/00

(52) U.S. Cl. CPC F03H 3/00

(57) ABSTRACT

Methods and systems are providing for generating relativistic motion of one or more nano particles. The methods include imposing a wave packet on the one or more nano particles by an electromagnetic field, the electromagnetic field including a vector potential AL perpendicular to the direction of the relativistic motion, where Aj_ is a function of an electron mass, an electron charge, a scalar potential summing a potential generated by nuclei of the one or more hydrogen atoms and an externally generated potential, and an electron velocity.

### FIELD OF THE INVENTION

The present invention relates to the fields of motors and arrangements for handling mechanical energy.

### BACKGROUND

Consider two bodies having volume elements d³x₁, d³x₂ located at \vec{x}₁, \vec{x}₂ respectively, having charge densities ρ₁ and ρ₂ and current densities \vec{J}₁ and \vec{J}₂. When an electric field \vec{E} and/or magnetic field \vec{B} of one of the bodies acts upon the fields of the other body, the Lorentz force is given as:

$${\vec{F}}_{21} = \int {d}^{3} {x}_{2} {ρ}_{i 2} ( \vec{E} + {\vec{v}}_{i 2} \times \vec{B} ) + \int {d}^{3} {x}_{2} {ρ}_{e 2} ( \vec{E} + {\vec{v}}_{e 2} \times \vec{B} ) \qquad ( 1 )$$

where ρᵢ₂ and ρₑ₂ are the ion charge density and electron charge density respectively, and νᵢ₂ and νₑ₂ are the ion velocity field and electron velocity field respectively. The total charge density is the sum of the ion charge density and free electron charge density, hence: ρ₂=ρᵢ₂+ρₑ₂.

As described in Rajput and Yahalom, “Newton's Third Law in the Framework of Special Relativity for Charged Bodies,” Symmetry 2021, 13, 1250, which is incorporated herein in its entirety by reference, when first and second charged bodies are combined as a charged motor, they can obtain non-vanishing momentum for stationary charge and current densities, due to the retardation time of electromagnetic field, as indicated by the following equation for momentum \vec{P}(t):

$$\vec{P} ( t ) = - \frac{{μ}_{0}}{4 π} \int \int {d}^{3} {x}_{1} {d}^{3} {x}_{2} ( {ρ}_{J} {\vec{J}}_{2} + {ρ}_{2} {\vec{J}}_{1} ) {R}^{- 1}$$

where \vec{R}≡\vec{x}₁₂=\vec{x}₁−\vec{x}₂, R≡|x₁−x₂|.

Hence the charged motor produces forward momentum without interacting with any external system except its own electromagnetic field. The above expression can be simplified using non-retarded scalar potentials such that:

$$\vec{P} ( t ) = - \frac{1}{{c}^{2}} [ \int {d}^{3} {x}_{2} {Φ}_{1} {\vec{J}}_{2} + \int {d}^{3} {x}_{1} {Φ}_{2} {\vec{J}}_{1} ]$$

in which

$$\frac{{μ}_{0}}{4 π k} = {μ}_{0} {ϵ}_{0} = \frac{1}{{c}^{2}} .$$

Another observation is that in a charged motor we do not need both subsystems to be charged to achieve momentum, so that if ρ₂=0, then

$$\vec{P} ( t ) = - \frac{{μ}_{0}}{4 π} \int \int {d}^{3} {x}_{1} {d}^{3} {x}_{2} {ρ}_{1} {\vec{J}}_{2} {R}^{- 1} = - \frac{1}{{c}^{2}} \int {d}^{3} {x}_{2} {Φ}_{1} {\vec{J}}_{2} \qquad ( 7 )$$

provided that the system has a non-vanishing current density \vec{J}₂.

As described with respect to the “relativisitic engine” in Tuval and Yahalom, “Newton's Third Law in the Framework of Special Relativity,” Eur. Phys. J. Plus, 2014, 129, 240, which is incorporated herein in its entirety by reference, the forward momentum gained by the mechanical system will be balanced by a backward momentum gained by the electromagnetic system. However, limitations to the achievable momentum exist due to dielectric breakdown. These limitations may be relaxed in the microscopic domain.

### SUMMARY

Embodiments of the present invention provide a system and methods whereby atomic particles generate a momentum, due to the retardation time of electromagnetic fields. Two configurations are presented, one in which a hydrogen electron is put in a wave packet state rather than in an eigenstate. The wave packet is typically localized to a subatomic scale. In order to change the state of the hydrogen atom from the ground state to any desired state a suitable Hamiltonian is constructed, by an appropriate electromagnetic field.

Alternatively, symmetry breaking may be achieved by adding an additional proton to a hydrogen atom.

### BRIEF DESCRIPTION OF DRAWINGS

For a better understanding of various embodiments of the invention and to show how the same may be carried into effect, reference will now be made, by way of example, to the accompanying drawings. Structural details of the invention are shown to provide a fundamental understanding of the invention, the description, taken with the drawings, making apparent to those skilled in the art how the several forms of the invention may be embodied in practice. In the accompanying drawings:

FIG. 1 is a schematic diagram of an exemplary wave packet (also referred to as a “wave function”) of a hydrogen atom configured as a nano relativistic motor, according to some embodiments of the invention;

FIG. 2 is a graph of a magnetic field B, of a hydrogen atom configured as a nano relativistic motor;

FIG. 3 is a graph of a function I_{y}(B) of a hydrogen atom configured as a nano relativistic motor;

FIGS. 4A-C are graphs of electric potential and force of a hydrogen atom in a low excited state with a symmetry breaking proximate protein; and

FIGS. 5A-C are graphs of electric potential and force of a hydrogen atom in a low excited state with a symmetry breaking proximate protein.

### DETAILED DESCRIPTION

Dielectric breakdown limits the momentum that can be gained by a charged, relativisitic macroscopic motor, that is, a motor. In the microscopic domain, this limitation is less restrictive. For example, for ionic crystals such as in table salt: Na⁺Cl⁻, the crystal solidifies to a face centered cubic lattice in which the lattice constant is l=564.02 pm. Taking for example the 100 plane of this lattice, the charge density is periodic, with each half unit cell having a surface charge density of ±2 Coulomb/m². This is a thousand times larger than available for macroscopic charge densities. However, on the macroscopic scale, the average charge density is null. To circumvent this situation, the periodic charge density of the crystal must be accompanied by a current density distribution of the same period. That is, a microscopic distribution of periodic charge density will be beneficial if it is a accompanied by a current density distribution of the same period. Microscopic currents are associated with the electronic motion and electronic spin. The magnetization vector \vec{M} is related to the magnetization current \vec{J}_{M} by the formula of Maxwell:

$${\vec{J}}_{M} ≡ \vec{∇} \times \vec{M} .$$

In addition, the magnetization \vec{M} is relate to microscopic dipole moments \vec{m} by the equation:

$$\vec{M} ≡ \frac{1}{V} {\sum }_{i} {\vec{m}}_{i} .$$

In the microscopic scale relevant to the nano engine, matter is composed of electrons and nuclei which are put together to become natural atoms, ions, molecules and lattice structures.

For Schrodinger's electron (in which the spin property is ignored) the non-relativistic probability density and current density satisfy a continuity equation obtained from the time-dependent wave-equation:

$$i ℏψ = \hat{H} ψ , \hat{H} = - \frac{{ℏ}^{2}}{2 m} {\vec{∇}}^{2} + V \qquad ( 16 )$$

here i=\sqrt{−1} and ψ is a complex function.

$$ψ ≡ \frac{\partial ψ}{\partial t}$$

is the partial time derivative of the complex wave function.

$$ℏ = \frac{ℏ}{2 π}$$

denotes Planck's constant divided by 2π and m is the mass, V is the potential function. We introduce the modulus a and phase ϕ through:

$$ψ = a {e}^{i ϕ} \qquad ( 17 )$$

The following continuity equation is satisfied provided that ψ satisfies Equation (16):

$$\frac{\partial \tilde{ρ}}{\partial t} + \vec{∇} \cdot {\vec{J}}_{p} = 0 \qquad ( 18 )$$

in which the probability density is defined as:

$$\tilde{ρ} = {a}^{2} \qquad ( 19 )$$

and is of course normalized, that is:

$$\int \tilde{ρ} {d}^{3} x = 1. \qquad ( 20 )$$

The probability current density is:

$${\vec{J}}_{p} = \frac{ℏ}{m} \tilde{ρ} \vec{∇} ϕ .$$

As the charge density of an electron with charge −e is:

$$π = - e \tilde{p}$$

it follows that the current density is:

$$\vec{J} = - e {\vec{J}}_{p} = - \frac{ℏ e}{m} \tilde{ρ} \vec{∇} ϕ = \frac{ℏ}{m} ρ \vec{∇} ϕ , \qquad ( 23 )$$

If spin is to be taken into account, we must use the Pauli equation (for a non-relativistic particle):

$$i ℏ \dot{ψ} = \hat{H} ψ , \hat{H} = - {\frac{{ℏ}^{2}}{2 m} [ \vec{∇} - \frac{ie}{ℏ c} \vec{A} ]}^{2} + μ \vec{B} \cdot \vec{σ} + V \qquad ( 25 )$$

in this context ψ is a two dimensional complex column vector (a spinor), Ĥ is now a two dimensional hermitian operator matrix, μ describes the magnetic moment. The electromagnetic interaction is given through \vec{A} and V potentials and the magnetic field B̅=\vec{∇}×Ā. \vec{σ} is a vector of Pauli matrices as follows:

$${σ}_{1} = ( \begin{matrix}0 & 1 \\ 1 & 0\end{matrix} ) , {σ}_{2} = ( \begin{matrix}0 & - i \\ i & 0\end{matrix} ) , {σ}_{1} = ( \begin{matrix}0 & 1 \\ 1 & 0\end{matrix} ) \qquad ( 26 )$$

A spinor ψ satisfying Equation (25) will also satisfy a continuity equation:

$$\frac{\partial \tilde{ρ}}{\partial t} + \vec{∇} \cdot {\vec{J}}_{p} = 0. \qquad ( 27 )$$

In the above:

$$\tilde{ρ} = {ψ}^{†} ψ , {\vec{J}}_{p} = ℏ = \frac{ℏ}{2 mi} [ {ψ}^{†} \vec{∇} ψ - ( \vec{∇} {ψ}^{†} ) ψ ] - \frac{e}{mc} \vec{A} \tilde{ρ} . \qquad ( 28 )$$

ψ^{†} describes a row vector (the transpose) whose components are the complex conjugate of ψ.

The following spinor representation is given in Holland, The Quantum Theory of Motion; Cambridge University Press: Cambridge, UK, 1993:

$$ψ = Re \text{?} ( \begin{matrix}cos ( \frac{\text{?}}{2} e \text{?} ) \\ i sin ( \frac{\text{?}}{2} e \text{?} )\end{matrix} ) ≡ ( \begin{matrix}ψ ↑ \\ ψ ↓\end{matrix} ) .$$

$$\text{?} \text{indicates text missing or illegible when filed}$$

Thus, the probability density is:

$$ρ = {ψ}^{†} ψ = {R}^{2} ⇒ R = \sqrt{\overline{ρ}} .$$

Furthermore, the charge density is:

$$ρ = - e \tilde{ρ} = - e {ψ}^{†} ψ = - {eR}^{2} .$$

The spin density can be represented as

$$\hat{s} ≡ \frac{{ψ}^{†} \vec{σ} ψ}{ρ} = ( sin {θ}^{′} sin {ϕ}^{′} , sin {θ}^{′} cos {ϕ}^{′} , cos {θ}^{′} )$$

This gives an obvious physical interpretation to θ′ and ϕ′ as angles that describe the projections of the spin density, where θ′ is the elevation angle and ϕ′ is the azimuthal angle. The probability current density can be derived as the expression:

$${\vec{J}}_{p} = \frac{ℏ}{2 m} \tilde{ρ} ( \vec{∇} χ + cos {θ}^{′} \vec{∇} {ϕ}^{′} ) - \frac{e}{mc} \tilde{ρ} \vec{A} . \qquad ( 33 )$$

This can be simplified to give

$${\vec{J}}_{p} = \frac{ℏ}{2 m} \tilde{ρ} ( \vec{∇} χ + cos {θ}^{′} \vec{∇} {ϕ}^{′} ) . \qquad ( 34 )$$

This gives the electric current density as:

$$\vec{J} = - e {\vec{J}}_{p} = - \frac{e ℏ}{2 m} \tilde{ρ} ( \vec{∇} χ + cos {θ}^{′} \vec{∇} {ϕ}^{′} ) = \frac{ℏ}{2 m} ρ ( \vec{∇} χ + cos {θ}^{′} \vec{∇} {ϕ}^{′} ) . \qquad ( 35 )$$

### The Hydrogen Atom

In a hydrogen atom, the proton is a positive charge +e at the origin, such that the potential Φ₁ of Eq. (7) is generated by the proton. The voltage V of Eq. (16) is thus felt by the electron as

$$V = - e Φ = - \frac{{ke}^{2}}{r} . \qquad ( 36 )$$

The electron wave function can be of the form:

$$ψ = e \text{?} {ψ}_{n} , \hat{H} {ψ}_{n} = {E}_{n} {ψ}_{n} \qquad ( 37 )$$

$$\text{?} \text{indicates text missing or illegible when filed}$$

In which ψₙ is a spatial Eigenfunction of the Hamiltonian Ĥ with Eigenenergy Eₙ. The electron can be in a definite energy state or in a superposition of states. The functional form of ψₙ is well known and is given in terms of the spherical coordinates r, θ, φ as follows:

$${ψ}_{nlm} = \sqrt{{( \frac{2}{{na}_{0}} )}^{3} \frac{( n - l - 1 ) !}{2 n ( n + l ) !}} e \text{?} r \text{?} {L}_{n - l - 1}^{2 l + 1} ( {r}^{′} ) {Υ}_{l}^{m} ( θ , φ ) . \qquad ( 38 )$$

$$\text{?} \text{indicates text missing or illegible when filed}$$

In the above L^{2l+1}ₙ₋ₗ₋₁ is the generalized Laguerre polynomial of degree n−l−1, Υₗ^{m}(θ,φ) is a spherical harmonic function of degree/and order in defined as:

$${Υ}_{l}^{m} ( θ , φ ) = {( - 1 )}^{m} \sqrt{\frac{2 l + 1}{4 π} \frac{( l - m ) !}{( l + m ) !}} {P}_{l}^{m} ( cos θ ) {e}^{im φ} . \qquad ( 39 )$$

In which Pₗ^{m} are associated Legendre polynomials. The definition also contains the reduced Bohr radius:

$${a}_{0} ≡ \frac{4 π {e}_{0} {ℏ}^{2}}{{m}_{e}^{′} {e}^{2}} ≃ \frac{{ℏ}^{2}}{{km}_{e} {e}^{2}} ≃ {0.531}^{- 10} m , {m}_{e}^{′} ≡ \frac{{m}_{e} {m}_{p}}{{m}_{e} + {m}_{p}} ≃ {m}_{e} \qquad ( 40 )$$

in which mₑ and mₚ are the masses of the electron and proton, respectively. Finally we use a normalized radial coordinate r′ defined as:

$${r}^{′} ≡ \frac{2 r}{{na}_{0}} . \qquad ( 41 )$$

The Eigen energies defined in Equation (37) are functions of the principal quantum number n=1, 2, 3 . . . :

$${E}_{n} = - \frac{{m}_{e}^{′} {e}^{4}}{32 {π}^{2} {e}_{0}^{2} {ℏ}^{2}} \frac{1}{{n}^{2}} . \qquad ( 42 )$$

Hence the function ψₙₗₘ is degenerate in the sense that different functions have the same energy. The degeneracy can be removed if there is a perturbation that changes the potential V to a form that is not spherically symmetric. For a given energy the different Eigen functions are listed by their azimuthal quantum number l=0, 1, 2, . . . , n−1 and their magnetic quantum number m=−l, . . . , 1. Note that the amplitude of the wave function given in Equation (37) is a function of r and θ, but not of ϕ and the time t. That is,

$$a ( r , θ ) = \vert ψ \vert = \vert {ψ}_{nlm} \vert ⇒ ρ = - e {\vert {ψ}_{nlm} \vert}^{2} . \qquad ( 43 )$$

Notice, also that the phase is a function of time and ϕ but not of r and θ:

$$ϕ ( φ , t ) = m ( φ + π ) - \frac{{E}_{n} t}{\text{?}} . \qquad ( 44 )$$

$$\text{?} \text{indicates text missing or illegible when filed}$$

The current density can then be calculated as:

$$\text{?} = \frac{\text{?}}{{m}_{e}} ρ \text{?} ϕ = - m \frac{e \text{?}}{{m}_{e}} {\vert {ψ}_{nlm} \vert}^{2} \frac{\text{?}}{r sin θ} \qquad ( 45 )$$

$$\text{?} \text{indicates text missing or illegible when filed}$$

(Note that the magnetic number m should not be confused with the mass mₑ.) In the above we have used the spherical representation of the nabla operator which is given in terms of the unit vectors r, θ, ϕ as:

$$\text{?} = \text{?} \frac{\partial }{\partial r} + \frac{\text{?}}{r} \frac{\partial }{\partial θ} + \frac{\text{?}}{r sin θ} \frac{\partial }{\partial φ} . \qquad ( 46 )$$

$$\text{?} \text{indicates text missing or illegible when filed}$$

As indicated, the current density is linear in the magnetic number m. For m=0 there is no current density and thus no relativistic motor effect. Therefore, for an isolated hydrogen atom in the ground state, n=1, l=0, m=0, there is no relativistic motor effect. Moreover, in excited states in which the current density does not necessarily vanish there is also no relativistic motor effect when the potential acting on the electron is spherically or cylindrically symmetric. This is evident from Equation (7), given that:

$$\text{?} = - sin φ \hat{x} + cos φ \text{?} \qquad ( 47 )$$

$$\text{?} \text{indicates text missing or illegible when filed}$$

\hat{x} and ŷ are constant unit vectors in the x and y directions, respectively. In spherical coordinates the volume element is:

$${d}^{3} x = {r}^{2} sin θ drd θ d φ \qquad ( 48 )$$

since Φ|ψₙₗₘ|² is cylindrically symmetric it does not depend on φ.

The volume charge density of an electron in a hydrogen atom has an order of magnitude of:

$$\text{?} = \frac{e}{\frac{4}{3} π {a}_{0}^{3}} ≃ 2.6 {10}^{11} Coloumb / {m}^{3} . \qquad ( 49 )$$

$$\text{?} \text{indicates text missing or illegible when filed}$$

The surface charge density of an electron in a hydrogen atom has an order of magnitude:

$$\text{?} = \frac{e}{4 π {a}_{0}^{2}} ≃ 4.5 Coloumb / {m}^{2} . \qquad ( 50 )$$

$$\text{?} \text{indicates text missing or illegible when filed}$$

The order of magnitude of the current density is then given as:

$$\text{?} = \frac{e \text{?}}{{m}_{e} {a}_{0}^{4}} ≃ 2.3 {10}^{18} Ampere / {m}^{2} = 2.3 {10}^{14} Ampere / {cm}^{2} \qquad ( 51 )$$

$$\text{?} \text{indicates text missing or illegible when filed}$$

This current density is ten orders of magnitude larger than what can be achieved on a macroscopic scale. The current density can also be represented as a velocity that is large, but still significantly smaller than the speed of light:

$$\overline{v} = \frac{\text{?}}{\overline{ρ}} ∼ 9.1 {10}^{6} m / s = 0.03 c \qquad ( 52 )$$

$$\text{?} \text{indicates text missing or illegible when filed}$$

### A Wave Packet of Hydrogen Atom Eigenstates

For a wave packet of the form:

$$ψ = A \text{?} , A = \{ \begin{matrix}\sqrt{\text{?}} & r < {R}_{max} \\ 0 & r \geq {R}_{max}\end{matrix} \qquad ( 53 )$$

$$\text{?} \text{indicates text missing or illegible when filed}$$

k′ and ρ̅_{c} are constants. As the wave function must be normalized ρ̅_{c} must take the following value:

$${\tilde{ρ}}_{c} = \frac{3}{4 π} {R}_{max}^{- 3} \qquad ( 54 )$$

This wave packet has a linear phase and a uniform amplitude which is confined inside a sphere of radius Rmax.

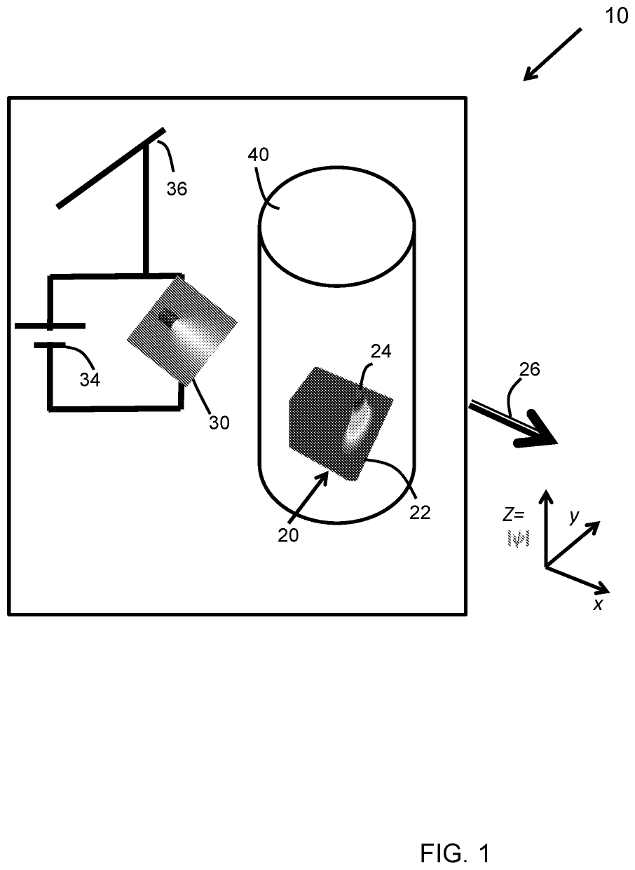

FIG. 1 shows an exemplary system 10 applying a wave packet 20 to a nano particle such as a hydrogen atom, the figure showing an x-y slice 22 of the wave packet and the associated amplitude 24 of the wave packet at points of the slice. As described hereinbelow, relativistic momentum 26 of the nano particle is generated. System 10 typically includes a generator 30 of an electromagnetic field that generates the wave packet 20. The generator may be a photonic wave generator, such as a laser, or any other known apparatus for electromagnetic field generation, or combination of apparatus, including an electric field generator applied by parallel plates and a magnetic field generator (e.g., inductive coil). The generator 30 may be powered by a battery 34, which may be chargeable, for example by a charge source such as a photoelectric panel 36. The nano particle may be one of a bulk configuration of particles contained in a container 40, such that the entire system gains momentum. Such a system may operate as a land, water, air, or space vehicle.

It is to be understood that the wave packet is not an eigenstate of the hydrogen atom Hamiltonian but may be approximated by a superposition of the eigenstates:

$$ψ ≃ {\sum }_{nlm} {a}_{nlm} ( t ) {ψ}_{nlm} \qquad ( 55 )$$

Functions aₙₗₘ(t) can be calculated using the orthonormality properties of the eigen functions:

$${a}_{nlm} ( t ) = < {ψ}_{nlm} \vert ψ >= \int {d}^{3} x {ψ}_{nlm}^{*} ψ \qquad ( 56 )$$

Preparation of such a state requires an electromagnetic field in accordance with Equation (25). Alternatives for the required vector and scalar potential of the electromagnetic field include the following.

If Aₓ=0 (vector potential in the direction of motion) then:

$${A}_{⊥} = \pm \frac{\sqrt{2 m}}{e} \sqrt{E ( t ) - e Φ - \frac{1}{2} {mv}^{2}}$$

in which A_{⊥} is the vector potential in a direction perpendicular to the motion, m is the electron mass, e is the electron charge, E(t) is an function of time with units of energy, set such that A_{⊥} is real and different from zero. Φ is the scalar potential (which is a sum of the potential generated by hydrogen nucleus and an externally generated potential), v is the electron velocity.

If Aₓ≠0 then:

$${A}_{x} = \frac{1}{e} ( m v \pm \sqrt{2 mE ( t ) - 2 m e Φ - {e}^{2} {A}_{⊥}^{2}} )$$

The current density can be calculated as:

$$J = - \frac{ℏ e}{{m}_{e}} \tilde{ρ} \vec{∇} ϕ = - \frac{ℏ ke}{{m}_{e}} {\tilde{ρ}}_{c} \hat{x} = - ev {\tilde{ρ}}_{c} \hat{x} for r < {R}_{max} , v ≡ \frac{ℏ {k}^{′}}{{m}_{e} ,} \qquad ( 57 )$$

where v has the units of velocity. Returning to the system described by Eq. 7, having two bodies, the first is taken as the proton and the second is taken as the electron, the proton taken as a point charge located at the origin of axis. This gives a charge for the proton of:

$${ρ}_{1} = e {δ}^{( 3 )} ( {\vec{x}}_{1} ) \qquad ( 58 )$$

From the above equations for charge and current density, we can determine momentum to be:

$$\vec{P} ( t ) = - \frac{{μ}_{0}}{4 π} \int \int {d}^{3} {x}_{1} {d}^{3} {x}_{2} {ρ}_{1} {\vec{J}}_{2} {R}^{- 1} = - \frac{{μ}_{0} e}{4 π} \int {d}^{3} {x}_{2} {\vec{J}}_{2} {r}_{2}^{- 1} . \qquad ( 59 )$$

Integrating, simplifying, and normalizing the above result gives:

$$\vec{P} ( t ) = \frac{3}{8 π} {μ}_{0} {e}^{2} {vR}_{max}^{- 1} \hat{x} . \qquad ( 61 )$$

In short, the momentum gained by a hydrogen atom with a wave packet spatial extension Rmax is linearly proportional to the electron's “velocity” v and inversely proportional to the wave packet spatial extension. The maximal speed generated by the hydrogen relativistic motor is obtained when the atom only carries its own mass (mₚ), which is then:

$${v}_{max} = \frac{P}{{m}_{p}} = \frac{3}{8 π {m}_{p}} {μ}_{0} {e}^{2} {vR}_{max}^{- 1} . \qquad ( 62 )$$

In order to obtain a predefined velocity vₘₐₓ we need a wave packer of radius:

$${R}_{max} = \frac{3 {μ}_{0} {e}^{2} v}{8 π {m}_{p} {v}_{max}} . \qquad ( 63 )$$

For example, for a velocity of vₘₐₓ=50 m/s, we obtain a wave packet of about a quarter of an atomic size, i.e.:

$${R}_{50} ≃ 1.4 {10}^{- 11} m = 0.26 {a}_{0}$$

### Symmetry Breaking

As described above, imposing on an electron of a hydrogen atom a wave packet that is a superposition of eigenstates causes the atom to act as a relativistic motor, gaining momentum due to retardation time of the charge fields. Alternatively, the hydrogen atom can act as a relativistic motor if the symmetry of the atomic potential is broken, for example by introducing a second proton at a distance d from the hydrogen atom (such as by ionization of an H₂ molecule). For example, with addition of an additional proton at location:

$${\vec{x}}_{1} = - d \hat{x}$$

we can calculate the potential generated as:

$${Φ}_{𝕝} ( \vec{x} ) = \frac{ke}{\sqrt{{d}^{2} + {r}^{2} + 2 dr sin θ cos φ}} . \qquad ( 76 )$$

The dependence of the potential on the angle φ indicates the potential's symmetry breaking. The momentum of the system is then determined to be:

$$\vec{P} = \frac{{μ}_{0}}{4 π} {eJma}_{0} {\int }_{0}^{∞} rdr {\int }_{0}^{m} d θ {\int }_{0}^{2 π} d φ \frac{{A}^{′2}}{\sqrt{{d}^{2} + {r}^{2} + 2 dr sin θ cos φ}} ( - sin φ \hat{x} + cos φ \hat{y} ) .$$

In the above, the current density J is a function given by Eq. 51, 51), m is the magnetic quantum number (not the mass), and φ is given through Equation (47). Finally:

$${A}^{′} ( r , θ ) = \vert {ψ}_{nlm} \vert {a}_{0}^{\frac{3}{2}} \qquad ( 78 )$$

is the dimensionless state amplitude in which we suppress the quantum indices nlm. The above expression can be somewhat simplified as follows:

$$\vec{P} = \frac{{μ}_{0}}{4 π} {eJma}_{0} {\int }_{0}^{∞} \frac{rdr}{\sqrt{{d}^{2} + {r}^{2}}} {\int }_{0}^{π} d θ {A}^{′2} {\int }_{0}^{2 π} d φ \frac{- sin φx + cos φ \hat{y}}{\sqrt{1 + B cos φ}} , \qquad ( 79 )$$

in the above:

$$B ( r , θ , d ) ≡ \frac{2 rd sin θ}{{d}^{2} + {r}^{2}} , 0 \leq B \leq 1. \qquad ( 80 )$$

The cylindrical symmetry is restored when B=0. This happens for either small d or large d, that is if the proton is too close or too far from the electron:

$${lim}_{d -> 0} B = {lim}_{d -> ∞} B = 0. \qquad ( 81 )$$

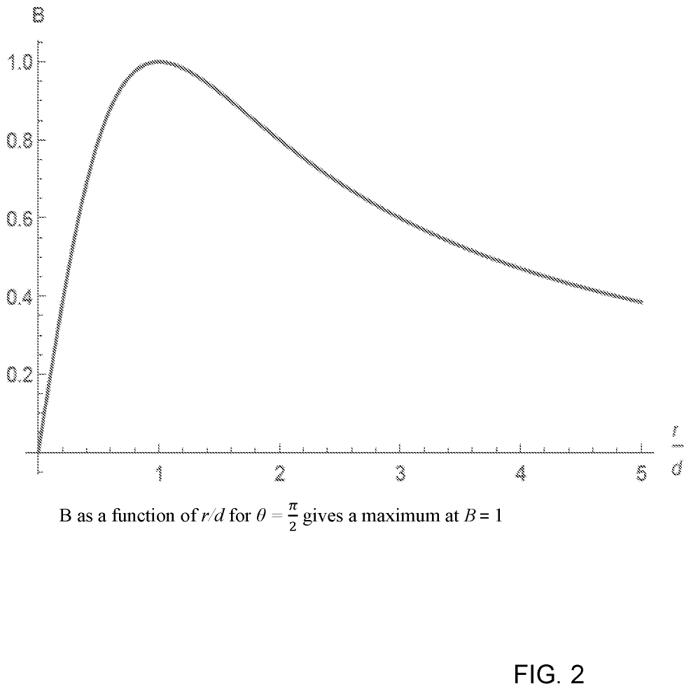

Hence a relativistic motor effect may occur only in intermediate values of d. For sin θ≥0 as θ∈[0, π], we are only interested in B≥0. We also notice that the maximal value of B is for θ=π/2. Showing B as a function of r/d for θ=π/2 gives a maximum at B=1, as depicted in FIG. 2.

A triple integral needs to be evaluated in order to calculate the momentum, this cannot be done using only analytic techniques, however, at least part of the integration can be done analytically. Consider the integrals:

$${I}_{x} ( B ) ≡ {\int }_{0}^{2 π} d φ \frac{sin φ}{\sqrt{1 + B cos φ}} , {I}_{y} ( B ) ≡ {\int }_{0}^{2 π} d φ \frac{cos φ}{\sqrt{1 + B cos φ}} . \qquad ( 82 )$$

Integrating analytically we arrive at the following results:

$${I}_{x} ( B ) = 0 , {I}_{y} ( B ) = \frac{4 ( 1 + B ) {Elliptic}_{E} ( \frac{2 B}{1 + B} ) - 4 {Elliptic}_{K} ( \frac{2 B}{1 + B} )}{B \sqrt{1 + B}} . \qquad ( 83 )$$

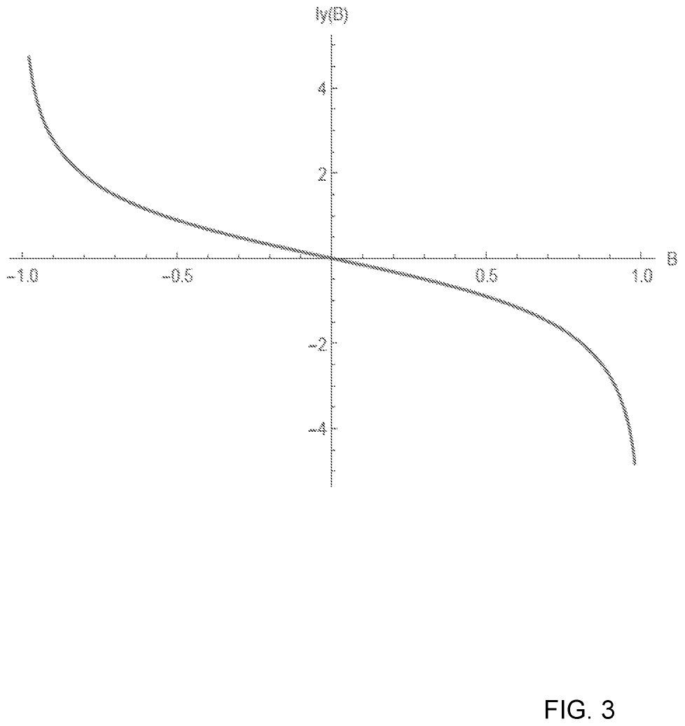

In the above Elliptic_{E} and Elliptic_{K} are the elliptic E and K functions, respectively. The function I_{y} is an even function that is I_{y}(B)=I_{y}(−B), as depicted in FIG. 3.

Because B≥0 it follows that I_{y}(B)≤0, thus only the righthand part of FIG. 3 is of interest. Because I_{y}(B) is a monotonic decreasing function of B, the larger values of B which are around r=d for θ=π/2 will make the most significant contribution (in absolute terms) to I_{y}(B). For B=1 this function is singular, however, the singularity will be integrated away when integrating over θ. The result is counter intuitive, in that the momentum is generated in the y direction despite the fact that proton which breaks the symmetry is located in the x direction, that is:

$$\vec{P} = \frac{{μ}_{0}}{4 π} e \overline{J} {ma}_{0} {\int }_{0}^{∞} \frac{rdr}{\sqrt{{d}^{2} + {r}^{2}}} {\int }_{0}^{π} d θ {A}^{′2} {I}_{y} ( B ) \tilde{y} . \qquad ( 84 )$$

Next, we define the function F as follows:

$$F ≡ {\int }_{0}^{π} d θ {A}^{′2} {I}_{y} ( B ) \qquad ( 85 )$$

F will become larger if both A⁰^{²} and I_{y} are peaked at the same r value, if the overlap is small so will be the relativistic momentum. We can thus write the momentum P in the form:

$$\vec{P} = \frac{{μ}_{0}}{4 π} e \overline{J} {ma}_{0} {\int }_{0}^{∞} \frac{rdr}{\sqrt{{d}^{2} + {r}^{2}}} F \hat{y} = \frac{{μ}_{0}}{4 π} e \overline{I} \frac{{a}_{0}^{3}}{d} m {\int }_{0}^{∞} F \frac{( \frac{r}{{a}_{0}} ) d ( \frac{r}{{a}_{0}} )}{\sqrt{1 + {( \frac{r}{d} )}^{2}}} \hat{y} . \qquad ( 86 )$$

Thus, \vec{P} is given in the form:

$$\vec{P} = \overline{P} \tilde{P} \hat{y} . \qquad ( 87 )$$

in which P̅ is a dimensional constant independent of the quantum state of the electron:

$$\overline{P} = \frac{{μ}_{0}}{4 π} e \overline{J} \frac{{a}_{0}^{3}}{d} . \qquad ( 88 )$$

Furthermore, P̅ is dimensionless, and depends on the quantum state.

$${\tilde{P}}_{nlm} = m \frac{{u}^{2}}{4} {\int }_{0}^{∞} {F}_{nlm} \frac{{r}^{′} {dr}^{′}}{\sqrt{1 + {( \frac{{r}^{′}}{{d}^{′}} )}^{2}}} . \qquad ( 89 )$$

In the above we have made explicit the dependence on the quantum numbers and have made use of the normalized r′ defined in Equation (41) and also introduced a normalized d′using a similar definition:

$${d}^{′} ≡ \frac{2 d}{{na}_{0}} . \qquad ( 90 )$$

We also notice that since the hydrogen Eigen state is given as a function of r′ and also B being dimensionless can be written in terms of dimensionless quantity:

$$B = \frac{2 {r}^{′} {d}^{′} sin θ}{{d}^{′2} + {r}^{′2}} . \qquad ( 91 )$$

it follows that P̅ₙₗₘ only depends on the quantum state and d′.

For the case d=2a₀, the Hamiltonian of the electron is modified significantly and thus will have different eigenstates from the ones that are obtained for an isolated hydrogen atom. Hence the eigenstates described in Equation (38) can only be considered as a superposition of the true eigenstates. In this case:

$$\overline{P} = \frac{{μ}_{0}}{8 π} e \overline{J} {a}_{0}^{2} ≃ 5.3 {10}^{- 29} Kg \text{m/s} \qquad ( 92 )$$

The velocity associate withe this momentum is:

$$\overline{υ} = \frac{\overline{P}}{2 {m}_{p}} ≃ 0.016 \text{m/s} , \qquad ( 93 )$$

in we have taken into account both the mass of the proton and the mass of the hydro-genatom. Hence for an unloaded relativistic motor we will obtain a velocity of:

$$\vec{υ} = \frac{\overline{P}}{2 {m}_{p}} ≃ 0.016 \tilde{P} \hat{y} \text{m/s} . \qquad ( 94 )$$

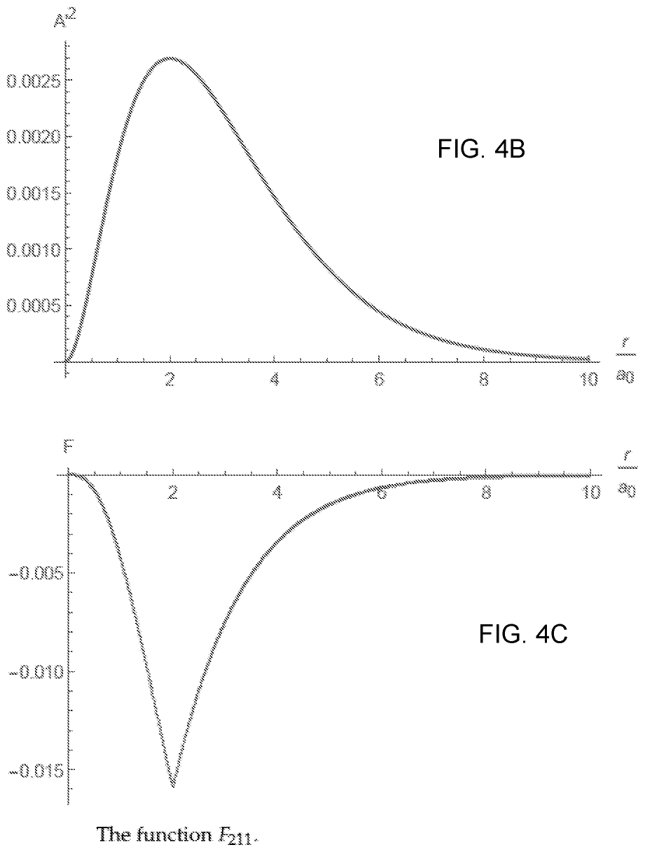

We investigate two excited cases, a low excited state n=2, l=1, m=1, and a high excited state n=4, l=3, m=3. The square amplitude 1211 is shown in FIG. 4A.

It is seen that the function describes tori of equal value. The function peaks at θ=π/2 r=2a₀. A cross section of the same for θ=π/2 is shown in FIG. 4B. This in turn provides a solution for F₂₁₁ in Eq. (85), which is shown in FIG. 4C.

Finally using F₂₁₁ we can calculate numerically P̅₂₁₁ using Equation (89) and obtain

$${\tilde{P}}_{211} ≃ - 0.047 . \qquad ( 95 )$$

Hence according to Equations (87) and (94) we obtain:

$${\vec{P}}_{211} ≃ - 2.47 {10}^{- 30} \hat{y} \text{kg m/s} \qquad ( 96 )$$

$${\vec{υ}}_{211} \text{=≃} - 7.4 {10}^{- 4} \hat{y} \text{m/s} .$$

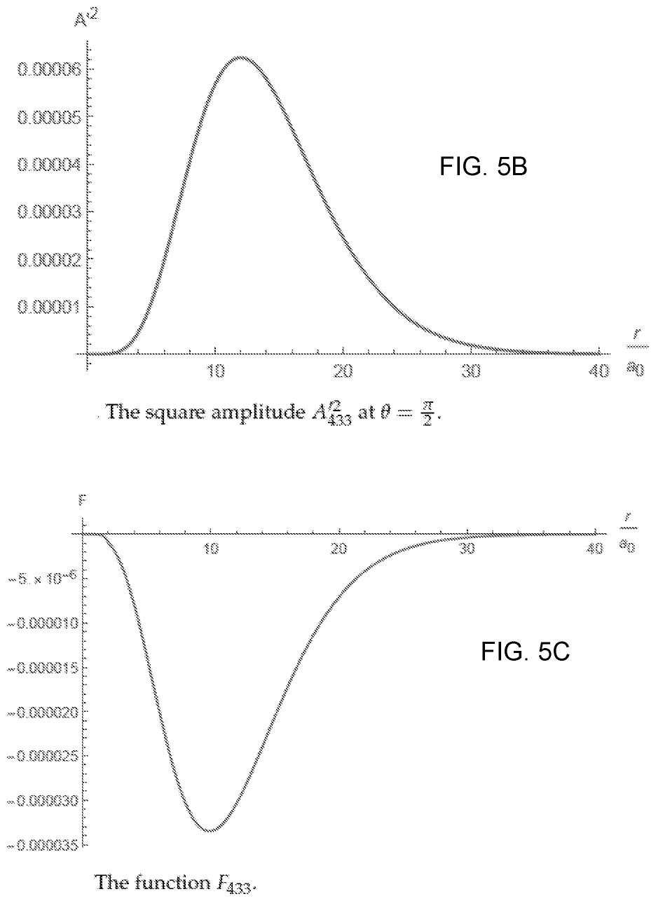

Similarly, solving for the high excited state n=4, l=3, m=3, gives values for the square amplitude and force F₄₃₃ as shown in FIGS. 5A-5C. From F₄₃₃ we can calculate numerically the system momentum from Equation (89) and obtain the value:

$${\tilde{P}}_{433} ≃ - 0.002 . \qquad ( 97 )$$

this is surprisingly smaller than P₂₁₁, but can be understood due to the small overlap between I_{y}(B) and A₄₃₃^{r2} . Now according to Equations (87) and (94) we obtain:

$${\vec{P}}_{433} ≃ - 1.05 {10}^{- 31} \hat{y} kg m / s {\vec{v}}_{211} = ≃ - 3.1 {\text{.10}}^{- 5} \hat{y} m / s . \qquad ( 96 )$$

Higher excited states were also analyzed, but did not show improvements for momentum or velocity.

### EXAMPLES

A first example of the present invention is a method of imparting kinetic energy to a system, including: 1) positioning one or more atoms, each having a nucleus and one or more electrons, in a specified volume of the system; 2) generating a quantum state such that the Lorentz force, defined as,

$${\vec{F}}_{T}^{[ 2 ]} = \frac{{μ}_{0}}{4 π} {\partial }_{t} \int \int {d}^{3} {x}_{1} {d}^{3} {x}_{2} [ \frac{1}{2} ( {ρ}_{2} {\partial }_{t} {ρ}_{1} - {ρ}_{1} {\partial }_{t} {ρ}_{2} ) \hat{R} - ( {ρ}_{1} {\vec{J}}_{2} + {ρ}_{2} {\vec{J}}_{1} ) {R}^{- 1} ]$$

is not null; wherein the quantum state is generated using an electromagnetic field with specific spatial and temporal properties designed to generate the said quantum state.

In a third example of the present invention the specified volume of the first example is defined by a container.

In a fourth example, the quantum state is a wave packet moving in a specific direction.

In a fifth example, the quantum state is an asymmetric wave packet.

In a sixth example, the quantum state is a superposition of states. In a further example 7, the states may be eigenstates of an unperturbed system, unperturbed meaning before applying an additional electromagnetic field.

In an example 8, the electromagnetic field is a form of radiation. In a further example 9, the radiation is applied as a finite set of frequencies.

In an example 10, symmetry of the unperturbed electrostatic field that is generated by the nuclei is broken by putting another nucleus in its vicinity.

In an example 11, the electromagnetic field is in a magnetic form.

In an example 12, the electromagnetic field is in an electric form.

In an example 13, electromagnetic field is a sum of electric, magnetic and radiation forms.

In an example 14, the electromagnetic field is generated by driving a changing electric current through a coil encircling the container.

In an example 15, a radius of an asymmetric wave packet of one of the one or more electrons is Rₘₐₓ=3μ₀e2v/8πmₚvₘₐₓ, μ₀ is vacuum magnetic permeability, e is the electron charge, v is the velocity of the wave packet, mₚ is the proton mass, and vₘₐₓ is the unloaded engine velocity.

An example 16 of the present invention is a method of generating relativistic motion of one or more hydrogen atoms, including imposing a wave packet on the one or more hydrogen atoms by an electromagnetic field, the electromagnetic field including a vector potential A_{⊥} perpendicular to the direction of the relativistic motion, where

$${A}_{⊥} = \pm \frac{\sqrt{2 m}}{e} \sqrt{E ( t ) - e Φ - \frac{1}{2} m {v}^{2}}$$

in which A_{⊥} is the vector potential in a direction perpendicular to the motion, m is electron mass, e is electron charge, E(t) is a function of time with units of energy, set so that A_{⊥} is real and non-zero, Φ is a scalar potential summing a potential generated by nuclei of the one or more hydrogen atoms and an externally generated potential, and v is electron velocity.

An example 17 of the present invention is a vehicle configured for ground, sea, air and/or space travel by relativistic motion of multiple hydrogen atoms, including: a container confining the multiple hydrogen atoms; and an electromagnetic field generator imposing a wave packet on the multiple hydrogen atoms.

An example 18 includes the features of example 17 and further includes a photoelectric panel and a battery for powering the electromagnetic field generator.

It is to be understood with respect to the above description that although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. Meanings of technical and scientific terms used herein are to be commonly understood as by one of ordinary skill in the art to which the invention belongs, unless otherwise defined. It is to be understood that the invention can be carried out or practiced in various ways and that the invention can be implemented in certain embodiments other than the ones outlined in the description above. Method steps associated with the system and process can be rearranged and/or one or more such steps can be omitted to achieve the same, or similar, results to those described herein.

1. A method of generating relativistic motion of one or more nano particles, comprising imposing a wave packet on the one or more nano particles by an electromagnetic field, wherein the electromagnetic field includes a vector potential A_{⊥} perpendicular to the direction of the relativistic motion, where
$${A}_{⊥} = \pm \frac{\sqrt{2 m}}{e} \sqrt{E ( t ) - e Φ - \frac{1}{2} m {v}^{2}}$$
in which A_{⊥} is the vector potential in a direction perpendicular to the motion, m is electron mass, e is electron charge, E(t) is a function of time with units of energy, set to ensure that A_{⊥} is real and not 0, Φ is a scalar potential summing a potential generated by nuclei of the one or more hydrogen atoms and an externally generated potential, and v is electron velocity.

2. The method of claim 1, wherein the one or more nano particles are hydrogen atoms.

3. A vehicle configured for ground, sea, air and/or space travel by relativistic motion of multiple nano particles, comprising:
a container confining the on or more nano particles;
an electromagnetic field generator imposing a wave packet on the one or more nano particles, the electromagnetic field including a vector potential A_{⊥} perpendicular to the direction of the relativistic motion, where A_{⊥} is a function of an electron mass, an electron charge, an arbitrary function of time with units of energy, a scalar potential summing a potential generated by nuclei of the one or more hydrogen atoms and an externally generated potential, and an electron velocity.

4. The vehicle of claim 3, further comprising a photoelectric panel and a battery for powering the electromagnetic field generator.

5. A method of imparting kinetic energy to a system, the method comprising:
Positioning one or more atoms, each having a nucleus and one or more electrons, in a specified volume of the system.
Generating a quantum state such that the equation:
$${\vec{F}}_{T}^{[ 2 ]} = \frac{{μ}_{0}}{4 π} {\partial }_{t} \int \int {d}^{3} {x}_{1} {d}^{3} {x}_{2} [ \frac{1}{2} ( {ρ}_{2} {\partial }_{t} {ρ}_{1} - {ρ}_{1} {\partial }_{t} {ρ}_{2} ) \hat{R} - ( {ρ}_{1} {\vec{J}}_{2} + {ρ}_{2} {\vec{J}}_{1} ) {R}^{- 1} ]$$
is not null.
The said quantum state is generated using an electromagnetic field with a specific spatial and temporal properties designed to generate the said quantum state.

6. The method of claim 5, where the said atoms are hydrogen atoms.

7. The method of claim 5, where the specified volume is defined by a container.

8. The method of claim 5, where the quantum state is a wave packet moving in a specific direction.

9. The method of claim 5, where the quantum state is an asymmetric wave packet.

10. The method of claim 5, where the quantum state is a superposition of states.

11. The method of claim 10, where the states are eigenstates of an unperturbed system.

12. The method of claim 5, where the electromagnetic field is in radiation form.

13. The method of claim 12, where the radiation is applied in a finite set of frequencies.

14. The method of claim 5, where the symmetry of the unperturbed electrostatic field generated by the nuclei is broken by putting another nucleus in its vicinity such as to generate a non-zero relativistic engine force.

15. The method of claim 5, where the said electromagnetic field is in a magnetic form.

16. The method of claim 5, where the said electromagnetic field is in an electric form.

17. The method of claim 5, where the said electromagnetic field is a sum of electric, magnetic and radiation forms.

18. The method of claim 5, wherein the electromagnetic field is generated by driving a changing electric current through a coil encircling the container.

19. The method of claim 5, wherein a radius of the asymmetric wave packet of the electron is Rₘₐₓ=3μ₀e2v/8πmₚvₘₐₓ, where μ₀ is vacuum magnetic permeability, e is the electron charge, v is the velocity of the wave packet, mₚ is the proton mass, and vₘₐₓ is the unloaded engine velocity.
